(19) United States
(12) Patent Application Publication
(10) Pub. No.: US 2015/0314965 A1
(43) Pub. Date: Nov. 5, 2015

(54) Handling Systems and Methods

(71) Applicant: Delkor Systems, Inc., St. Paul, MN (US)

(72) Inventor: Matthew Henry Churchill, Blaine, MN (US)

(73) Assignee: Delkor Systems, Inc., St. Paul, MN (US)

(21) Appl. No.: 14/701,975

(22) Filed: May 1, 2015

Related U.S. Application Data
(60) Provisional application No. 61/987,988, filed on May 2, 2014.

(51) Int. Cl. B65G 47/24; B65G 37/00

(52) U.S. Cl. CPC B65G 47/24; B65G 37/00

(57) ABSTRACT

One or more systems for handling one or more articles, wherein at least one article has a first orientation that deviates from a desired orientation. One or more systems include an infeed conveyor system including an infeed conveyor belt moving at a first speed and an aligning conveyor system including an aligning conveyor belt moving at a second speed and/or a static surface and having portions that form a trough in which an article may be oriented in a sliding engagement to a second orientation that deviates from the desired orientation less than the first orientation. One or more methods include contacting an aligning conveyor system having an aligning conveyor belt and/or a static surface that forms a trough with an article that has a first orientation that deviates from a desired orientation and allowing the article to move laterally within the trough to a second orientation that deviates from a desired orientation less than the first orientation.

### CROSS-REFERENCE TO RELATED APPLICATIONS

This application claims the benefit of provisional U.S. Patent Application Ser. No. 61/987,988 (entitled Handling Systems and Methods, filed on May 2, 2014), which is hereby incorporated herein by reference in its entirety.

### STATEMENT REGARDING FEDERALLY SPONSORED RESEARCH

Not Applicable.

### BACKGROUND OF THE INVENTION

Various types of handling systems (e.g., packaging assemblies, etc.) are known in the art. Existing handling systems, however, lack the ability to quickly and efficiently package products having non-standard or unpredictable orientation and/or alignment. Consequently, there remains a need in the handling systems (e.g., packaging, etc.) industry to efficiently orient and/or align articles (e.g., packages, pouches, etc.) having non-standard and/or unpredictable orientation and/or alignment. In particular, there remains a need to orient and/or align articles in a predictable manner so that the articles can be packaged.

All US patents and applications and all other published documents mentioned anywhere in this application are incorporated herein by reference in their entirety.

Without limiting the scope of the present disclosure, a brief summary of some of the claimed embodiments is set forth below. Additional details of the summarized embodiments and/or additional embodiments of the present disclosure may be found in the Detailed Description of the Invention below.

A brief abstract of the technical disclosure in the specification is provided as well only for the purposes of complying with 37 C.F.R. §1.72. The abstract is not intended to be used for interpreting the scope of the claims.

### SUMMARY

In one or more aspects of the present disclosure, a system (e.g., for handling an article) includes an infeed conveyor system and at least one aligning conveyor system.

In some embodiments, the infeed conveyor system includes an infeed conveyor belt that is configured and arranged to receive a plurality of articles and convey the plurality of articles in an infeed downstream direction at a first speed (e.g., first linear speed). Generally, the plurality of articles includes at least one article having a first orientation that deviates from a desired orientation.

In some embodiments, an aligning conveyor system includes an aligning conveyor belt that includes a trough that extends in an aligning downstream direction. In some embodiments the aligning conveyor belt includes a first portion and a second portion, the first and second portions forming a trough.

In one or more embodiments, the aligning conveyor belt is configured and arranged to receive the disoriented article (e.g., from the infeed conveyor system into the trough of the aligning conveyor belt), to slidingly engage the disoriented article (e.g., in order to passively orient the disoriented article to a second orientation that deviates from the desired orientation less than the first orientation), and to convey the article in a further downstream direction at a second speed (e.g., second linear speed).

In some embodiments, an aligning conveyor system includes a static surface that includes a trough that extends in an aligning downstream direction. In some embodiments the static surface includes a first portion and a second portion, the first and second portions forming a trough.

In one or more embodiments, the static surface is configured and arranged to receive the disoriented article (e.g., from the infeed conveyor system into the trough of the static surface), to slidingly engage the disoriented article (e.g., in order to passively orient the disoriented article to a second orientation that deviates from the desired orientation less than the first orientation), and to allow the article to slide off the static surface in a further downstream direction at an exit speed (e.g., exit linear speed). In some embodiments, the static surface includes a stop surface along which an article can slide in an abutting fashion (e.g, in a downstream direction). In some embodiments, the static surface includes a combination of points or protrusions along each of which the article may slide. In some embodiments, the static surface includes one or more components (e.g., rollers, etc.) that may further affect the article's movement while at least partially slidingly engaging the static surface.

In some embodiments, the sliding engagement of the disoriented article on the aligning conveyor belt and/or static surface may be useful in laterally positioning the article near to or nearer to the direction defined by the bottom of the trough. In one or more embodiments, an article has a center of gravity and the aligning conveyor belt and/or static surface is configured and arranged to slidingly engage the article in order to reduce a lateral distance between the center of gravity and the aligning downstream direction extending from the bottom of the trough.

In one or more embodiments, each of the first portion and second portion (e.g., of the aligning conveyor belt, of the static surface, etc.) has a laterally inclined surface that is at least 1 degree from level. In some embodiments, the aligning conveyor system includes one or more beveled guides (e.g., adjustable beveled guides, etc.) over which the first and second portions of the aligning conveyor belt travel.

In some embodiments, an aligning conveyor system includes at least two upstream aligning end rollers, wherein a first upstream aligning end roller defines a first axis of rotation, wherein a second upstream aligning end roller defines a second axis of rotation, and wherein the first axis of rotation is not parallel to the second axis of rotation. For example, the first axis may be oriented at least 1 degree from level and the second axis may be oriented at least 1 degree from level. In some embodiments, the upstream end of the trough is formed by at least two upstream aligning end rollers. In some embodiments, the trough is V-shaped or u-shaped (e.g., in a cross-section of the trough taken perpendicular to the downstream direction, the trough may be generally V-shaped or U-shaped). In some embodiments, the V-shape or U-shape includes a gap (e.g., a space or separation) at the bottom of the V- or U-shape.

In some embodiments, the the infeed conveyor belt is horizontal (e.g., laterally and/or in the downstream direction). In one or more embodiments, an aligning conveyor belt and/or the static surface is disposed at a lower elevation than a downstream end of the infeed conveyor belt. For example, the bottom of the trough (e.g., of the aligning conveyor belt, of the static surface) and a top of the downstream end of the infeed conveyor belt may differ in elevation by any suitable amount (e.g., 100% or more of at least one dimension (e.g., thickness, length, or width) of the article).

In some embodiments, the trough of the aligning conveyor belt extends over a first longitudinal length of the aligning conveyor bed and the aligning conveyor bed further includes a flat aligning bed that extends over a second longitudinal length of the aligning conveyor bed. An aligning conveyor bed may further include a transition that extends between the trough and the flat aligning bed, which may be located downstream of the trough.

In one or more embodiments, the aligning conveyor belt includes at least a first aligning belt and a second aligning belt. In some embodiments, the aligning conveyor system includes a drive unit that drives both the first aligning belt and a second aligning belt over a common aligning conveyor bed. In some cases, the first and second aligning belts may rotate around a common axle at the downstream end of the aligning conveyor bed. In one or more embodiments, downstream of the trough, the first and second aligning belts combine to form a flat (e.g., laterally flat) aligning bed.

In one or more embodiments the aligning conveyor belt includes modular plastic. For example, the modular plastic may include modules that allow the belt to accommodate turns or tortuous paths. Modular plastic belts are well-known in the art and are commercially available (e.g., Intralox, L.L.C., Harahan, La.).

In some embodiments, the infeed conveyor belt defines an infeed conveying plane (e.g., along which articles are conveyed). In one or more embodiments, the infeed conveyor belt is a flat belt (e.g., laterally and/or or in the downstream direction).

The systems and methods of the present disclosure may include any of a wide variety of article shapes and sizes. In some embodiments, an article includes a top, a bottom, and at least one side wall extending from the top to the bottom. Articles may be formed from any of a wide variety of packaging materials. For example, in some embodiments, at least one of the top, bottom, and sidewall may include polyethylene. In the present disclosure, an article may be considered to be a primary element (e.g., a flexible pouch). In one or more embodiments, the bottom of the article includes a gusset.

Further, an article may define a longitudinal direction (e.g., from the center of the top to the center of the bottom), which may be translated into the infeed conveying plane to define, for example, a first orientation.

In one or more embodiments, a part of the aligning conveyor belt (and/or the static surface) includes (e.g., is formed from, etc.) a urethane (e.g., polyurethane, etc) and/or a nylon.

In one or more embodiments, the coefficient of friction between the aligning conveyor belt (and/or the static surface) and the article is 0.3 or less. For example, the kinetic coefficient of friction between the aligning conveyor belt (and/or static surface) and the article may be 0.25 or less.

In one or more embodiments, the speed of the aligning conveyor belt is greater than (e.g., at least 50% greater than) the speed of the infeed conveyor belt. However, in some embodiments, the speed of the aligning conveyor belt is less than the speed of the infeed conveyor belt. In one or more embodiments including a static surface, the first speed is great enough to provide the article with sufficient momentum to slide along the static surface and then off the downstream end of the static surface at an exit speed. In some embodiments, the exit speed is less than the first speed by 5% or more (e.g., by 10% or more, by 25% or more, by 50% or more, etc.). However, in cases in which the static surface is inclined in a downstream direction, the exit speed may be less than, the same as, or even greater than the first speed.

In one or more embodiments, the difference between the first and second speeds is sufficient to avoid a stick and slip phenomenon (e.g., between the aligning conveyor belt and the article, etc.). In one or more embodiments, the difference between the first speed and the second speed is sufficient to cause the article to at least initially engage the aligning conveyor belt (and/or static surface) with friction having a coefficient of friction less than the static coefficient of friction (e.g., with kinetic friction). For example, in some embodiments, the aligning conveyor belt has a sufficiently low coefficient of friction, such that the at least one article will slide down (e.g., by gravity, etc.) one of the first and second portions to an aligned configuration.

In one or more aspects of the present disclosure, a method for orienting an article includes contacting at least one aligning conveyor system with an article that is moving in a downstream direction at a first speed (e.g., first linear speed) and that has a first orientation that deviates from a desired orientation and allowing the article to move laterally to a second orientation that deviates from a desired orientation less than the first orientation. The at least one aligning conveyor system may include an aligning conveyor belt that is moving at a second speed (e.g., second linear speed) and/or a static surface that is static. As described herein, the aligning conveyor belt (and/or the static surface) includes a first portion and a second portion, the first and second portions forming a trough. In one or more embodiments, the method includes allowing the article to move laterally within the trough to a second orientation that deviates from a desired orientation less than the first orientation.

In one or more embodiments of the present disclosure, the desired orientation is not greater than 10 degrees (e.g., not greater than 5 degrees, etc.) from true alignment. In one or more embodiments, the first orientation deviates from the desired orientation by 10 degrees or more. In one or more embodiments, the first orientation deviates from the desired orientation by 30 degrees or more.

### DEFINITIONS

As used herein, an “article” refers to an item that can travel on a conveyor of the present disclosure. In one or more embodiments, an “article” is a flexible pouch that may or may not contain a product such as a foodstuff.

As used herein, “downstream” refers to a direction defined by the path of travel of an article at rest on a moving conveyor belt. This may be referred to as the positive x-axis direction (see FIG. 1).

As used herein, “upstream” refers to a direction that is opposite the downstream direction. This may be referred to as the negative x-axis direction (see FIG. 1).

As used herein, “lateral” refers to a direction that is at a right angle to the downstream and upstream directions (e.g., across a conveyor belt). This may be referred to as the positive or negative y-axis direction (see FIG. 1). For example, a “lateral incline” refers to an inclined surface that has at least a component of slope in a direction at a right angle to the downstream and upstream directions. For example, a lateral dimension is a dimension measured at a right angle to the upstream and downstream direction. As used herein, “lateral” movement of an article refers to article movement having a lateral component, generally in combination with downstream components and/or elevation components of movement. In other words, an article moving “laterally” (i.e., having a lateral component of movement) may be simultaneously moving downstream (i.e., having a downstream component of movement) and/or downward in elevation (i.e., having an elevation component of movement).

As used herein, “level” (or “horizontal”) refers to a surface defining a plane that is at a predetermined height (e.g., a predetermined z-axis dimension).

As used herein, “orientation” (e.g., first orientation, second orientation, desired orientation, etc.) refers to a direction defined by an axis defined by an article (e.g., a direction extending from a bottom of the article to a top of the article). For example, “orientation” may refer to a direction from a center of a bottom of an article to a center of a top of the article. In some cases, that direction may then be translated to a reference plane (e.g., a horizontal plane, a plane defined by the surface of a conveyor belt on which an article travels, etc.). Unless otherwise specified, “orientation” of an article can be determined by viewing the article from above and can be quantified by measuring the angle between the orientation of the article and a reference axis (e.g., a downstream direction, a desired orientation, etc.).

Herein, the term “disoriented article” refers to an article (e.g., of a plurality of articles) having a first orientation that deviates from a desired orientation.

As used herein, “alignment” of an article refers to the positioning of the article at a predictable orientation. For example, two articles are said to be aligned (i.e., in alignment) when an axis defined by the first article is parallel (e.g., within a level of tolerance, etc.) to a similar axis defined by the second article. As one of skill in the art will recognize, articles that are aligned may or may not be at a desirable orientation (e.g., at an orientation that is within an orientation tolerance of a desired orientation). As one of skill in the art will recognize, articles that are aligned may or may not be at an orientation that is parallel to the downstream direction.

As used herein, “true alignment” refers to alignment of a plurality of articles according to a desired orientation that is parallel to the downstream direction of an aligning conveyor belt.

As used herein, a “belt” refer to a closed loop of material (e.g., a continuous or endless band of material) and/or an assembly of modular components (e.g., modular plastic components) that collectively form a closed loop of material. Thus, a “belt” may refer to a flexible modular belt, as are known to one of skill in the art.

As used herein, a “conveyor belt bed” generally refers to the upward-facing surfaces of a conveyor belt between rollers at the upstream end of a conveyor belt and at the downstream end of a conveyor belt.

As used herein, a “static surface” generally refers to a surface (or combination of surfaces) that does not move upstream or downstream directions and is configured and arranged to engage (e.g., frictionally, slidingly, etc.) one or more articles (e.g., received from the infeed conveyor system). In one or more embodiments, a “static surface” may be a slide, a chute, or an open channel. In one or more embodiments, a “static surface” may include a conveyor belt (or a portion thereof) that is not moving. However, as used herein a “static surface” may include one or more components that move rotationally (e.g., a roller rotating on a fixed axis, a first and/or second portion of the static surface that may rotate to adjust lateral incline, etc.).

As used herein, the term “degrees” refers to a measurement of plane angle that represents 1/360^{th} of a full rotation.

As used herein, “and/or” means any one or more of the items in the list joined by “and/or”. For example, “x and/or y” means any element of the three-element set {(x), (y), (x, y)}. For another example, “x, y, and/or z” means any element of the seven-element set {(x), (y), (z), (x, y), (x, z), (y, z), (x, y, z)}.

As used herein, the term “exemplary” means serving as a non-limiting example, instance, or illustration. As used herein, the terms “e.g.,” and “for example,” introduce a list of one or more non-limiting embodiments, examples, instances, and/or illustrations.

### BRIEF DESCRIPTION OF THE SEVERAL VIEWS OF THE DRAWING(S)

FIG. 1 depicts a perspective view of a system, according to one or more embodiments of the present disclosure, for handling articles, the system being shown in a process of handling a plurality of representative, but nonlimiting, articles.

FIG. 2 depicts a top view of a system, according to one or more embodiments of the present disclosure, for handling articles, the system being shown in a process of handling a plurality of representative, but nonlimiting, articles.

FIG. 3 depicts a downstream end view of a system, according to one or more embodiments of the present disclosure, for handling articles, the system being shown in a process of handling a plurality of representative, but nonlimiting, articles.

### DETAILED DESCRIPTION

Handling articles is useful in a wide variety of industries. In, for example, a packaging application, articles may be collated and arranged into groupings of articles (e.g., primary elements, etc.) for packaging into a larger container (e.g., for transport, etc.). In many cases, the orientation and/or alignment of the articles is not suitable for downstream packaging processes due to, for example, lack of conformity of orientation to a desired orientation. Thus, systems and methods for pre-conditioning the articles for packaging are useful.

When packaging one or more articles, some existing systems have utilized a system that includes, for example, detection of the articles (e.g., by visualization, etc.), determination of orientation of each article, robotics (e.g., robotic arms, etc.) to handle the articles, and, if desired, to reorient and/or align the articles into a predetermined orientation and/or alignment for further processing downstream. Such systems may include costly robotics hardware and software, costly detection systems, and/or may require a relatively large footprint in a processing facility. Thus, improved systems and methods for handling (e.g., preconditioning, etc.) articles are desired. In one or more embodiments, handling systems and methods of the present disclosure may affect (e.g., improve) on one or more performance metrics (e.g., predictability of the orientation and/or alignment of articles, handling volume, etc.) and may also offer reduced complexity of operation, reduced cost, and/or relatively small footprint of the system.

In one or more embodiments, the systems described herein are useful in orienting and/or aligning one or more articles (e.g., flexible pouches, etc.) that may be packaged in one or more downstream processes. For example, individual articles may have inserted therein a product (e.g., foodstuff, etc.) and may be placed on the system of the present disclosure out of alignment with other articles and/or at an orientation that may be undesirable (e.g., for downstream processing). Systems and methods may be useful in reducing and/or eliminating the occurrence of misalignment and/or undesirable orientation of one or more articles.

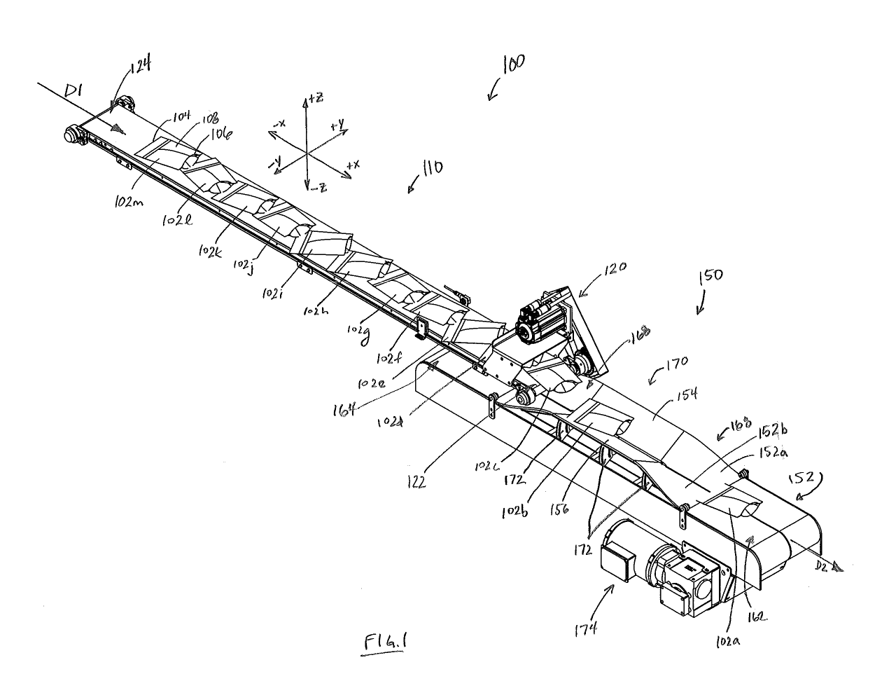

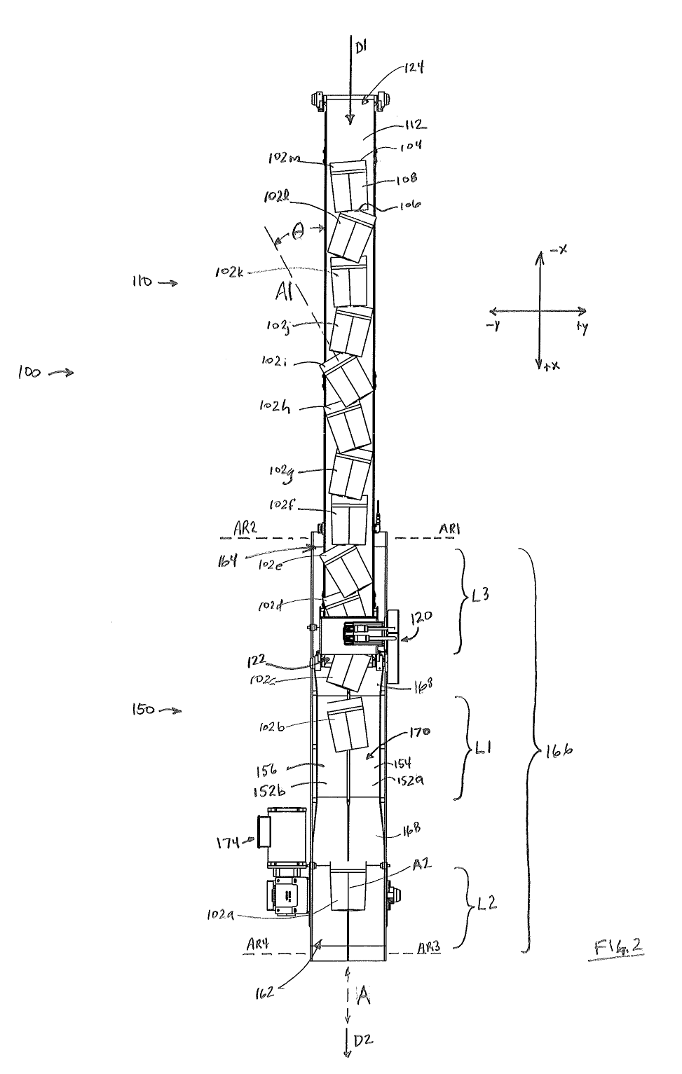

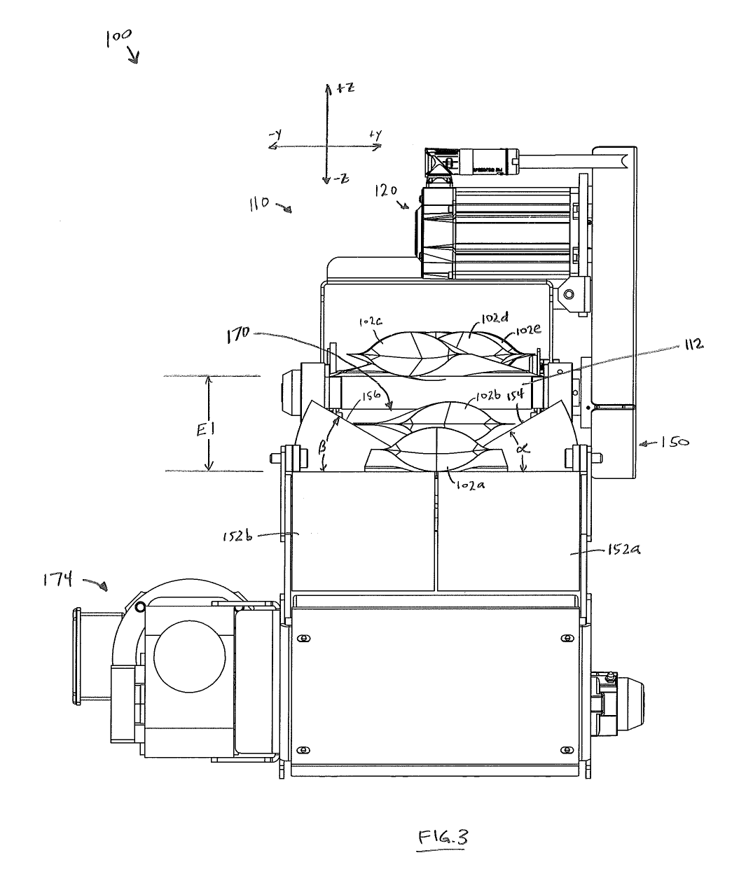

With regard to FIG. 1, a system 100 (e.g., for handling an article 102) includes an infeed conveyor system 110 and an aligning conveyor system 150. FIG. 2 shows the system of FIG. 1 from a top view perspective. FIG. 3 shows the system 100 of FIGS. 1 and 2 from an end view perspective.

In FIG. 1, the infeed conveyor system 110 includes an infeed conveyor belt 112 (e.g., an endless conveyor belt) that is configured and arranged to receive one or more articles 102. In FIG. 1, the articles 102 take the form of flexible pouches and include a top 104, a bottom 106 in the form of a gusset, and at least one side wall 108. As used herein, reference numeral 102 refers generically to one or more of the articles 102a-102m shown in FIGS. 1-3, whereas reference to a specific article of FIGS. 1-3 is made by adding a letter to the reference numeral 102 (e.g., 102a, 102b, 102c, . . . , 102m, etc.). The articles 102 may be received at or near the upstream end 124 of the infeed conveyor belt 112 (e.g., see upper left portion of FIG. 1 and top portion of FIG. 2). The infeed conveyor belt 112 is configured to convey one or more articles 102 in an infeed downstream direction D1 (e.g., toward the downstream end 122 of the infeed conveyor belt 112) at a first speed. In one or more embodiments, the infeed conveyor belt 112 is configured to receive a plurality of articles that includes at least one article (e.g., article 102i, article 102j, etc.) having a first orientation that deviates from a desired orientation. In one or more embodiments, one or more portions of the infeed conveyor belt 112 may be horizontal in the lateral direction, in the downstream direction, or both. As shown in FIG. 1, the whole infeed conveyor belt 112 is horizontal in both the lateral and downstream directions.

The aligning conveyor system 150 of FIG. 1 includes an aligning conveyor belt 152 (e.g., an endless conveyor belt) (and/or a static surface, not shown) that includes a first portion 154 and a second portion 156 that collectively form a trough 170. Generally, the first portion 154 is disposed laterally from the second portion 156. Trough 170 extends generally in an aligning downstream direction D2. The aligning downstream direction D2 extends in the direction defined by the path of travel of an article 102 at rest on the aligning conveyor belt 152 (e.g., from an upstream end 164 toward the downstream end 162 of the aligning conveyor belt 152). For example, the aligning downstream direction D2 in FIGS. 1 and 2 is in the positive x-axis direction. In some embodiments, the aligning downstream direction D2 is generally parallel to the infeed downstream direction D1, although a non-parallel relationship is possible when, for example, the aligning conveyor belt 152 is directed at an angle (e.g., a non-zero angle) relative to the infeed conveyor belt 112. In one or more embodiments wherein the aligning conveyor belt is fixed (i.e., second speed is zero), first portion 154 and second portion 156 of FIG. 1 is a static surface.

In one or more embodiments, the aligning conveyor belt 152 (and/or static surface) is configured and arranged to receive an article 102 from the infeed conveyor system 110 into the trough 170. Then the aligning conveyor belt 152 (and/or static surface) may slidingly engage the article 102 in order to passively orient the article 102 from the article's orientation on the infeed conveyor belt 112 (i.e., the first orientation) to a second orientation on the aligning conveyor belt 152 (and/or static surface). In one or more embodiments, the second orientation will deviate from a desired orientation less than the first orientation. In one or more embodiments, the aligning conveyor belt 152 then conveys the article 102 in a further downstream direction (e.g., the aligning downstream direction D2) at a second speed. In one or more embodiments, the article slides off the end of the static surface at an exit speed. For example, in one or more embodiments, an article may slide off the downstream end of the static surface and may thereafter contact a conveyor belt (e.g., a flat conveyor belt, an aligning conveyor belt as described herein, etc.).

FIGS. 1-3 show a plurality of articles 102 (e.g., articles 102a-102m) on the system 100 in various stages of handling. One of skill in the art will appreciate that article 102a was placed on the moving infeed conveyor belt 112 near the upstream end 124 at a first orientation (e.g., near the location of article 102m in FIG. 1) and was conveyed in a downstream direction D1 to the downstream end 162 of the aligning conveyor belt 152 (e.g., near the location of article 102c in FIG. 1). Then, article 102a continued onto the aligning conveyor system 150, which slidingly engaged the article 102a (e.g., near the location of article 102b) to orient article 102a into a second orientation that closely matches the desired orientation and conveyed article 102a to the location shown in FIG. 1. In the one or more embodiments of FIGS. 1-3, the desired orientation is defined by the bottom of the trough 170, which is in the positive x-axis direction. Thus, the orientation of article 102a has been adjusted to (or maintained at) the desired orientation for further processing.

It should be recognized that each of the articles 102b-102m follow article 102a and will be similarly processed, wherein the second orientation of each of articles 102b-102m will be similar to that shown for article 102a when each of articles 102b-102m reach the location of 102a.

In one or more embodiments, the speed of the aligning conveyor belt is different than the speed of the infeed conveyor belt. In one or more embodiments, the speed of the aligning conveyor belt is greater than the speed of the infeed conveyor belt (e.g., by 10% or more, by 25% or more, by 50% or more, by 100% or more, by 200% or more, etc.). In one or more embodiments, the speed of the aligning conveyor belt is less than the speed of the infeed conveyor belt (e.g., by 10% or more, by 25% or more, by 50% or more, by 75% or more, by 90% or more, by 99% or more, etc.). Because the aligning conveyor belt is configured and arranged to slidingly engage articles, it is useful for the difference in conveyor belt speeds to be great enough to induce that sliding engagement. Similarly, because the static surface is configured and arranged to slidingly engage articles, it is useful for the first speed of the infeed conveyor belt to be great enough to induce that sliding engagement.

In one or more embodiments, the difference in conveyor belt speeds between the infeed conveyor belt and the aligning conveyor belt is sufficient to substantially avoid a stick-and-slip phenomenon (or other similarly erratic engagement) when the aligning conveyor engages an article. In one or more embodiments, the difference in conveyor belt speeds between the infeed conveyor belt and the aligning conveyor belt is sufficient to cause an article to at least initially engage the aligning conveyor belt with friction having a coefficient of friction that is less than the static coefficient of friction (e g, kinetic friction) between the aligning conveyor belt and the article.

In one or more embodiments, the aligning conveyor belt (and/or the static surface) is configured and arranged to engage an article with a coefficient of friction of 0.30 or less (e.g., 0.25 or less, 0.20 or less, etc.). In some embodiments, the kinetic coefficient of friction between the aligning conveyor belt (and/or the static surface) and an article is 0.25 or less.

Articles of the present disclosure may include an outer surface made from any of a wide variety of materials including, but not limited to, materials used to form flexible pouches and/or to package foods or household goods. In one or more embodiments, an outer surface of an article (e.g., a surface in contact with the infeed conveyor belt and/or the aligning conveyor belt) may include polyethylene.

Aligning conveyor belts (and/or the static surface) of the present disclosure may include an article-engaging surface that is made from any of a wide variety of materials known in the conveyor belt industry and may include, but is not limited to, a urethane or a nylon. In one or more embodiments, the article-engaging surface of an aligning conveyor belt (and/or the static surface) is formed from a material having relatively low resistance to sliding (e.g., relatively low stick, relatively low tack, relatively low grip, etc.).

Any of a wide variety of aligning conveyor belt constructions may be suitable in the present disclosure including, but not limited to, modular plastic conveyor belts. In one or more embodiments, such as that shown in FIG. 1, it may be useful for the aligning conveyor belt 152 to be configured to transition from a traditional flat conveyor configuration to an inclined configuration and back to a flat conveyor configuration. As can be seen from FIG. 1, the length of the aligning conveyor belt 152 along the centerline is shorter than the length at the outer edges, due to the increased travel to the top edges of the trough 170, which also leads to increased travel speed along outer edges of the trough 170 relative to the bottom of the trough 170. For this reason, modular plastic conveyor belts may be useful in that the modular plastic components may accommodate such shape transitions and differences in travel distance and speed without the increased wear that might be exhibited by a traditional conveyor belt construction.

In one or more embodiments, the inclined configuration includes a first portion 154 having a lateral incline and a second portion 156 having a lateral incline. In one or more embodiments, the first portion 154 is laterally adjacent the second portion 156. In one or more embodiments, both of the first and second portions laterally incline downward to collectively form a trough 170. In some embodiments, the magnitude of the lateral incline of each of the first and second portions is independently at least 1 degree from horizontal (e.g., at least 5 degrees, at least 10 degrees, at least 20 degrees, at least 30 degrees, at least 40 degrees, etc.). For example, as shown in FIG. 3, the lateral incline a of the first portion 154 is about 30 degrees from horizontal and the lateral incline β of the second portion is about 30 degrees from horizontal. In some embodiments, the magnitude of the lateral incline of each of the first and second portions is independently not greater than 80 degrees from horizontal (e.g., not greater than 60 degrees, not greater than 45 degrees, not greater than 35 degrees, etc.). In some embodiments, the magnitude of the lateral incline of the first and second portions may be the same or different. Although not wishing to be bound by theory, it is believed that in some embodiments, a relatively shallow amount of lateral incline may be useful to adjust lateral position of an article (e.g., a flexible pouch) whereas a relatively steeper incline may be useful to adjust orientation of an article.

In one or more embodiments, as shown in FIG. 2, the trough 170 of the aligning conveyor belt 152 extends over a first longitudinal length L1 of the aligning conveyor bed 166. In some embodiments, the aligning conveyor bed 166 further includes a flat aligning bed that extends over a second longitudinal length L2 of the aligning conveyor bed 166 downstream of the trough 170. The aligning conveyor bed 166 may optionally include a flat aligning bed that extends over a third longitudinal length L3 of the aligning conveyor bed 166 upstream of the trough 170. As shown in FIG. 1, an aligning conveyor bed may also include one or more transition portions 168 that extend between the trough 170 and the one or more flat aligning beds.

In one or more embodiments, the aligning conveyor system 150 includes one or more beveled guides 172 over which the first and/or section portions of the aligning conveyor belt 152 travel. For example, three beveled guides 172 are shown in FIG. 1, each of which support second portion 156 of the aligning conveyor belt 152. Although hidden in the view of FIG. 1, similar beveled guides support first portion 154 of the aligning conveyor belt 152. In one or more embodiments, one or more beveled guides 172 (e.g., all beveled guides, etc.) may be adjustable (e.g., infinitely adjustable) to provide for reduced or increased incline of all or a portion of first and/or second portions of aligning conveyor belt 152. In one or more embodiments, one or more beveled guides 172 supports a part of one of the first and second portions of aligning conveyor belt 152 at an incline that is different from one or more of the other beveled guides 172. For example, a trough 170 with a varying amount of incline along its length may allow for an extended transition portion 168 or may be suitable for processing certain article geometries. In one or more embodiments, each of the one or more beveled guides 172 is adjustable on a real-time basis. For example, the systems described herein may further include a device (e.g., a mechanical visual detection device, etc.) to determine the extent of desired lateral movement and/or the extent of desired orientation adjustment of each individual article, use such a determination to identify a desired amount of incline of one, some, or all of the one or more beveled guides 172 in order to appropriately adjust lateral position and/or orientation of each individual article, and to actually increase or decrease the incline (if necessary) of one, some, or all of the one or more beveled guides 172 to effect that desired amount of incline. In one or more embodiments, the device could determine orientation characteristics of each of a plurality of articles in real-time and could adjust the incline of one, some, or all of the one or more beveled guides 172 in real time to accommodate each individual article. Benefits of real-time adjustment of beveled guide incline may include, for example, more consistent downstream position and/or orientation of the articles (e.g., smaller standard deviation of deviations of orientation from a desired orientation) and a smaller system footprint (e.g., due to reduced length of aligning conveyor belt to effect desired article orientation).

As an alternative to or in addition to the beveled guides 172, an aligning conveyor system 150 may include two upstream aligning end rollers (not shown), around which the aligning conveyor belt 152 travels, wherein one upstream aligning end roller defines a first axis of rotation (e.g., AR1 in FIG. 2) and the other upstream aligning end roller defines a second axis of rotation (e.g., AR2 in FIG. 2). In one or more embodiments, the first axis of rotation is not parallel to the second axis of rotation, but this is not required. In some embodiments, one or both of the first and second axes of rotation is inclined at least 1 degree (e.g., at least 5 degrees, at least 10 degrees, at least 20 degrees, at least 30 degrees, at least 40 degrees, etc.) from horizontal. In one or more embodiments, the two upstream aligning end rollers form the upstream end of the trough of the aligning conveyor belt.

In one or more embodiments wherein the aligning conveyor system includes a static surface, each of the first and second portions of the static surface may be inclined (e.g., adjustably inclined) in a manner described herein for first and second portions of the aligning conveyor belt. In one or more embodiments, the static surface includes a hinge between the first and second portions at the bottom of the trough such that the incline of at least one of the first and second portions may be adjusted.

An aligning conveyor system 150 may include two downstream aligning end rollers (not shown), around which the aligning conveyor belt 152 travels, wherein one downstream aligning end roller defines a first axis of rotation (e.g., AR3 in FIG. 2) and the other downstream aligning end roller defines a second axis of rotation (e.g., AR4 in FIG. 2). In one or more embodiments, the first axis of rotation is not parallel to the second axis of rotation, but this is not required. In some embodiments, one or both of the first and second axes of rotation is inclined at least 1 degree (e.g., at least 5 degrees, at least 10 degrees, at least 20 degrees, at least 30 degrees, at least 40 degrees, etc.) from horizontal. In one or more embodiments, the two downstream aligning end rollers form the downstream end of the trough of the aligning conveyor belt.

In some embodiments, the aligning conveyor system may include two aligning conveyor belts, each configured to travel laterally adjacent to the other. As used herein, 152 refers generically to the one or more aligning conveyor belts 152a-152b of FIGS. 1-3, whereas reference to a specific aligning conveyor belt is made by adding a letter to the reference numeral 152 (e.g., 152a, 152b). For example, the two side-by-side aligning conveyor belts may be configured such that one of the belts (e.g., first aligning conveyor belt 152a) forms one portion of the trough 170 (e.g., the first portion 154 of the aligning conveyor belt) and one of the belts (e.g., second aligning conveyor belt 152b) forms another portion of the trough 170 (e.g., the second portion 156 of the aligning conveyor belt). In some embodiments, the two aligning conveyor belts rotate around a common axis (e.g., around a common axle) at the downstream end 162 of the aligning conveyor bed 166 or, alternatively, around different axes (e.g., around different axles). In some embodiments, the aligning conveyor system 150 includes a drive unit 174 that drives both of the two side-by-side aligning conveyor belts over a common aligning conveyor bed 166. Alternatively, the two side-by-side aligning conveyor belts may be driven by separate drive units.

In FIG. 1, the aligning conveyor system 150 includes a drive unit 174 that is shown to drive the aligning conveyor belt 152 over both sides of the trough 170. In other words, the drive unit 174 is common to both aligning conveyor belts 152a and 152b. Any of a wide variety of drive units may be suitable for the present disclosure including, but not limited to, drive units having a constant speed drive motor. Also shown in FIG. 1, the infeed conveyor system 110 includes an independent drive unit 120 for driving the infeed conveyor belt. Any of a wide variety of drive units for the infeed conveyor system 110 may be suitable for the present disclosure including, but not limited to, a servo drive (e.g., infinitely adjustable).

In the present disclosure, a wide variety of infeed and aligning conveyor belt speeds (i.e., first and second speeds) are envisioned. The infeed conveyor belt 112 may receive, for example, 300 articles 102 per minute and the infeed conveyor belt speed may be such that the articles 102 are arranged longitudinally almost inline (as shown by articles 102c-102m in FIG. 1) or touching end to end. The speed of the aligning conveyor belt 152 may be sufficient to cause a kinetic frictional engagement with the articles 102, as further discussed herein, and to change (e.g., increase or decrease) the distance between the articles 102. For example, in FIG. 1, the aligning conveyor belt 152 is traveling at a second speed that is greater than the speed of the infeed conveyor belt 112, such that the distance between adjacent articles (e.g., article 102a and article 102b) is increased on the aligning conveyor belt 152 relative to the distance between adjacent articles (e.g., article 102m and article 102l) on the infeed conveyor belt 112. In one or more embodiments, this increase in distance between articles may be useful in downstream processing. In one or more embodiments in which the articles 102 have relatively large separations on the infeed conveyor belt 112, the speed of the aligning conveyor belt 152 may be relatively slow to decrease the distance between articles 102 on the aligning conveyor belt 152.

Any of a wide variety of trough shapes may be suitable in the present disclosure including, but not limited to, portions that are V-shaped (e.g., as shown in FIG. 1), U-shaped, flat-bottomed, rounded-bottomed, and others.

In one or more embodiments, the aligning conveyor belt (and/or the static surface) is disposed at a lower elevation (i.e., in a negative z-axis direction) than a downstream end of the infeed conveyor belt. For example, in FIG. 1, downstream end 122 of infeed conveyor belt 112 is disposed at a higher elevation than at least a portion of the aligning conveyor belt 152. In one or more embodiments, an article (e.g., article 102c) being conveyed beyond the downstream end 122 of infeed conveyor belt 112 falls (e.g., due to gravity, etc.) and initially engages the aligning conveyor belt 152 (e.g., the trough 170) at a lower elevation. Although not wishing to be bound by theory, it is believed that the elevation drop may provide a component of downward (i.e., negative z-axis direction) momentum, which may induce the article to shift orientation and/or lateral position toward the bottom of the trough. In some embodiments, the difference in elevation (e.g., E1 in FIG. 3) between the top surface of the infeed conveyor system 110 and the bottom of the trough 170 is in a range of greater than zero to less than five times the longest of the article's length, width, and thickness dimensions (e.g., the length of article 102a in the direction of the x-axis). In some embodiments, the elevation drop is less than the article's longest length, width, and thickness dimension (e.g., the length of article 102a in the direction of the x-axis). In some embodiments, the elevation drop is in a range of from about one to three times (e.g., about two times, etc.) at least one dimension (e.g., the thickness or the z-axis dimension for the articles 102 shown in FIG. 3) of the article. For example, the elevation drop E1 in FIG. 3 is approximately two times the thickness of article 102a. In one or more embodiments, the elevation drop is 30.5 centimeters or less (e.g., 25.4 cm or less, 22.9 cm or less, 15.2 cm or less, 7.6 cm or less, 2.5 cm or less, etc.).

In one or more embodiments, the system 100 will be configured to process an article 102 (or plurality of articles) to the desired orientation (within a level of desired orientation tolerance) wherein the article 102 is placed on the infeed conveyor belt 112 at the first orientation deviates by up to 45 degrees from the desired orientation (i.e., in a range of from −45 degrees to +45 degrees). In some embodiments, the article's first orientation deviates by up to 40 degrees (e.g., up to 35 degrees, up to 30 degrees, up to 25 degrees, up to 20 degrees, up to 15 degrees, up to 10 degrees, etc.) from the desired orientation. For example, in FIG. 2, article 102i has a first orientation (see axis A1 in FIG. 2) having a deviation θ of approximately 30 degrees from the desired orientation (see axis A in FIG. 2). Then, when article 102i reaches the position of article 102a in FIG. 2, then the angle of deviation from the desired orientation may be determined. The deviation of article 102a is zero degrees. In some embodiments, the article's first orientation deviates by at least 10 degrees (e.g., at least 15 degrees, at least 20 degrees, at least 25 degrees, at least 30 degrees, at least 35 degrees, at least 40 degrees, etc.) from the desired orientation.

In some embodiments, each of a plurality of articles 102 may have a particular first orientation (that may or may not be the same as the first orientation of the other articles of the plurality of articles) and may be processed by the system 100 to have a second orientation that is within the tolerance level of the desired orientation.

In one or more embodiments, the tolerance level of the desired orientation may be up to 10 degrees (i.e., 10 degrees in either direction from the desired orientation), but may, in some embodiments, have a reduced tolerance (e.g., up to 8 degrees, up to 6 degrees, up to 4 degrees, up to 2 degrees, up to 1 degree, up to 0.5 degrees, etc.).

In some embodiments, the system 100 may reduce the absolute value of deviation of an article's orientation at least 25% (e.g., at least 50%, at least 75%, at least 90%, at least 95%, etc.). For example, an article having a first orientation that deviates by 40 degrees from the desired orientation and a second orientation that deviates by 4 degrees (or −4 degrees) from the desired orientation would have a 90% reduction in orientation deviation.

As one of skill in the art would recognize, a plurality of articles 102 may define a set of first orientations that define a set of first angles and a set of second orientations that define a set of second angles. In one or more embodiments, system 100 processes a plurality of articles 102 such that a ratio of the average of the absolute values of the second set of angles to the average of the absolute values of the first set of angles is 0.9 or less (e.g., 0.75 or less, 0.50 or less, 0.25 or less, 0.10 or less, 0.05 or less, 0.01 or less, etc.). In one or more embodiments, system 100 processes a plurality of articles 102 such that a ratio of the standard deviation of the absolute values of the second set of angles to the standard deviation of the absolute values of the first set of angles is 0.9 or less (e.g., 0.75 or less, 0.50 or less, 0.25 or less, 0.10 or less, 0.05 or less, 0.01 or less, etc.).

The following table (Table 1) provides a sample calculation of the some of the values discussed herein for a plurality of articles (e.g., 10 articles) with a desired orientation of zero degrees (i.e., in the aligning downstream direction).

TABLE 1

| | | | Absolute | Absolute | |
|---|---|---|---|---|---|
| | First | Second | Value of | Value of | |
| | Orientation | Orientation | First | Second | |
| | Deviation | Deviation | Orientation | Orientation | Percent |
| | (in degrees) | (in degrees) | Deviation | Deviation | Reduction |
| | −45 | −2 | 45 | 2 | 96 |
| | 30 | 3 | 30 | 3 | 90 |
| | −20 | −1 | 20 | 1 | 95 |
| | −5 | 0 | 5 | 0 | 100 |
| | 10 | 1 | 10 | 1 | 90 |
| | −13 | −1 | 13 | 1 | 92 |
| | 40 | 3 | 40 | 3 | 93 |
| | 20 | 1 | 20 | 1 | 95 |
| | −3 | 0 | 3 | 0 | 100 |
| | 16 | 1 | 16 | 1 | 94 |
| Sum | 30 | 5 | 202 | 13 | |
| Average | 3.0 | 0.5 | | | 83 |
| Standard Deviation | 25.4 | 1.6 | | | 93 |

| | | | |
|---|---|---|---|
| Average of Absolute Values | 20.2 | 1.3 | 94 |
| Standard Deviation of Absolute Values | 14.2 | 1.1 | 93 |

| | |
|---|---|
| Ratio of Average of Second Set of Angles to Average of | 0.5/3.0 = 0.17 |
| First Set of Angles | |
| Ratio of Standard Deviation of Second Set of Angles to | 1.6/25.4 = 0.064 |
| Standard Deviation of First Set of Angles | |
| Ratio of Average of Absolute Values of Second Set of | 1.3/20.2 = 0.065 |
| Angles to Average of Absolute Values of First Set of Angles | |
| Ratio of Standard Deviation of Absolute Values of Second | 1.1/14.2 = 0.075 |
| Set of Angles to Standard Deviation of Absolute Values of | |
| First Set of Angles | |

Articles of the present disclosure generally have a center of gravity, as can be readily determined by one of skill in the art. In one or more embodiments, system 100 may be configured to guide an article 102 to or near a desired path extending from the bottom of the trough 170 (e.g., a path extending along a center line of the aligning conveyor belt). That is, system 100 may laterally move an article 102 that has a center of gravity that is a first distance from the desired path when traveling on the infeed conveyor belt 112 to a second distance from the desired path when travelling at the downstream end 162 of the aligning conveyor belt 152, wherein the second distance is shorter than the first distance. In this manner, not only is the orientation of an article 102 more predictable at the downstream end 162 of the aligning conveyor belt 152 (and/or the downstream end of the static surface) than at the upstream end 124 of the infeed conveyor belt 112, but the positioning of the article at the downstream end 162 of the aligning conveyor belt 152 (and/or the downstream end of the static surface) is also more predictable than at the upstream end 124 of the infeed conveyor belt 112. Averages and standard deviations of each of first and second distances from the desired path may be calculated for a plurality of articles in a manner similar to that presented above in Table 1 for angles of deviation. In one or more embodiments, the average of the second distances represents a reduction of the average of first distances by at least 25 percent (e.g., at least 50 percent, at least 75%, at least 90%, etc.). In one or more embodiments, the standard deviation of the second distances represents a reduction of the standard deviation of the first distances by at least 25 percent (e.g., at least 50 percent, at least 75%, at least 90%, etc.).

In one or more aspects of the present disclosure, a method for handling articles (e.g., for improving an orientation of an article, for preconditioning an article, etc.) may include contacting at least one aligning conveyor system with an article having a first orientation (as otherwise described herein) that deviates from a desired orientation and allowing the article to move laterally within a trough of the aligning conveyor system to a second orientation (as otherwise described herein) that deviates from a desired orientation less than the first orientation. For example, a method for handling articles can be seen in FIG. 1 that shows contacting an aligning conveyor system 150 with an article (e.g., article 102b) having a first orientation that deviates from a desired orientation (e.g., the aligning downstream direction D2) and allowing the article 102 to move laterally within trough 170 to a second orientation (e.g., represented by the orientation of article 102a) that deviates from the desired orientation less than the first orientation. In one or more embodiments, the article (e.g., article 102b) contacting the at least one aligning conveyor system 150 is moving in a downstream direction at a first speed. For example, in embodiments having an infeed conveyor system 110 having an infeed conveyor belt 112, the first speed is defined by the speed of the infeed conveyor belt 112.

In one or more embodiments, the aligning conveyor belt 152 is moving at a second speed (e.g., greater than the first speed of the article, etc.). The aligning conveyor belt 152 includes a first portion 154 and a second portion 156 that collectively form a trough 170.

In one or more embodiments, contacting an aligning conveyor belt 152 with an article 102 includes sliding engagement between the aligning conveyor belt 152 and the article 102 as is otherwise described herein. Similarly, in one or more embodiments, contacting a static surface with an article 102 includes sliding engagement between the static surface and the article 102 as is otherwise described herein.

In one or more embodiments, a system and/or method of the present disclosure is effective to adjust the orientation of an article toward a desired orientation (within a level of tolerance). In some embodiments, the desired orientation is 10 degrees or less from true alignment (i.e., in a range of from −10 degrees to +10 degrees from true alignment). In some embodiments, the desired orientation is 5 degrees or less from true alignment.

The above disclosure is intended to be illustrative and not exhaustive. This description will suggest many variations and alternatives to one of ordinary skill in this field of art. All these alternatives and variations are intended to be included within the scope of the claims where the term “comprising” means “including, but not limited to.” Those familiar with the art may recognize other equivalents to the specific embodiments described herein which equivalents are also intended to be encompassed by the claims.

Further, the particular features presented in the dependent claims can be combined with each other in other manners within the scope of the present disclosure such that the present disclosure should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g., each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

What is claimed is:

1. A system for handling an article, the system comprising:
an infeed conveyor system comprising an infeed conveyor belt that is configured and arranged to receive a plurality of articles and convey the plurality of articles in an infeed downstream direction at a first speed, wherein the plurality of articles comprises at least one article having a first orientation that deviates from a desired orientation; and
at least one aligning conveyor system comprising an aligning conveyor belt that comprises a first portion and a second portion, the first and second portions forming a trough that extends in an aligning downstream direction;
wherein the aligning conveyor belt is configured and arranged to receive the article from the infeed conveyor system into the trough, to slidingly engage the at least one article in order to passively orient the at least one article to a second orientation that deviates from the desired orientation less than the first orientation, and to convey the article in a further downstream direction at a second speed.

2. The system of claim 1, wherein the article has a center of gravity and wherein the aligning conveyor belt is configured and arranged to slidingly engage the at least one article in order to reduce a lateral distance between the center of gravity and the aligning downstream direction extending from the bottom of the trough.

3. The system of claim 1, wherein each of the first portion and second portion has a laterally inclined surface that is at least 1 degree from level.

4. The system of claim 1, wherein the at least one aligning conveyor system comprises beveled guides over which the first and second portions travel.

5. The system of claim 1, wherein the at least one aligning conveyor system comprises at least two upstream aligning end rollers, wherein a first upstream aligning end roller defines a first axis of rotation, wherein a second upstream aligning end roller defines a second axis of rotation, and wherein the first axis of rotation is not parallel to the second axis of rotation.

6. The system of claim 1, wherein the infeed conveyor belt is horizontal.

7. The system of claim 1, wherein the aligning conveyor belt is disposed at a lower elevation than a downstream end of the infeed conveyor belt.

8. The system of claim 1, wherein the trough extends over a first longitudinal length of an aligning conveyor bed and wherein the aligning conveyor bed further comprises a flat aligning bed that extends over a second longitudinal length of the aligning conveyor bed.

9. The system of claim 1 wherein the trough is V-shaped.

10. The system of claim 1, wherein the aligning conveyor belt comprises at least a first aligning belt and a second aligning belt.

11. The system of claim 1, wherein the infeed conveyor belt defines an infeed conveying plane.

12. The system of claim 1, wherein the aligning conveyor belt comprises modular plastic.

13. The system of claim 1, wherein at least a part of the aligning conveyor belt comprises a polyurethane and/or a nylon.

14. The system of claim 1, wherein a coefficient of friction between the aligning conveyor belt and the article is 0.3 or less.

15. The system of claim 1, wherein the second speed is greater than the first speed.

16. The system of claim 1, wherein the second speed is less than the first speed.

17. A system for handling an article, the system comprising:
an infeed conveyor system comprising an infeed conveyor belt that is configured and arranged to receive a plurality of articles and convey the plurality of articles in an infeed downstream direction at a first speed, wherein the plurality of articles comprises at least one article having a first orientation that deviates from a desired orientation; and
at least one aligning conveyor system comprising a static surface that comprises a first portion and a second portion, the first and second portions forming a trough that extends in an aligning downstream direction;
wherein the static surface is configured and arranged to receive the article from the infeed conveyor system into the trough, to slidingly engage the at least one article in order to passively orient the at least one article to a second orientation that deviates from the desired orientation less than the first orientation, and to allow the article to slide off the static surface in a further downstream direction at an exit speed.

18. A method for orienting an article, the method comprising:
contacting at least one aligning conveyor system with an article that is moving in a downstream direction at a first speed and that has a first orientation that deviates from a desired orientation;
wherein the at least one aligning conveyor system comprises an aligning conveyor belt that is moving at a second speed;
wherein the aligning conveyor belt comprises a first portion and a second portion, the first and second portions forming a trough;
allowing the article to move laterally within the trough to a second orientation that deviates from a desired orientation less than the first orientation.

19. The method of claim 18, wherein the desired orientation is within 10 degrees of true alignment.

20. The method of claim 18, wherein the first orientation deviates from the desired orientation by 10 degrees or more.
